(19) United States
(12) Patent Application Publication
(10) Pub. No.: US 2009/0140454 A1
(43) Pub. Date: Jun. 4, 2009

(54) BELT-TYPE APPARATUS FOR CONTINUOUS PLATE FORMATION AND METHOD OF CONTINUOUS PLATE FORMATION WITH BELT

(75) Inventors: Tomonari Murakami, Hiroshima (JP); Hirotoshi Mizota, Hiroshima (JP); Hajime Okutsu, Hiroshima (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI RAYON CO., LTD., MINATO-KU (JP)

(21) Appl. No.: 11/996,595

(22) PCT Filed: Jul. 25, 2005
(86) PCT No.: PCT/JP2005/013577

§ 371 Date: Apr. 22, 2008

(51) Int. Cl. B29D 7/00; B29C 39/16

(52) U.S. Cl. 264/216; 425/86

(57) ABSTRACT

Disclosed is an apparatus for continuous plate formation using belts, in which a polymerizable raw material is fed to one end of a space surrounded by opposed surfaces of two endless belts 1 and 1′ facing each other and by gaskets 7 disposed at side edges of these belt surfaces so as to be sandwiched between the surfaces, the polymerizable raw material is polymerized in a section where the belts are heated or cooled with warm water, and a plate-form polymer is taken out of the other end of the space, which contains three or more recovery vessels 13 for recovering the warm water used to heat or cool the belts, and temperature sensing elements (thermometers 14) for measuring the temperature of the warm water recovered in every recovery vessel 13. Also disclosed is a method of continuous plate formation using belts, which comprises producing a plate-form polymer from a polymerizable raw material containing methyl methacrylate while measuring temperature of warm water recovered in every recovery vessel 13 with thermometers 14 by using the apparatus for continuous plate formation using belts.

### TECHNICAL FIELD

The present invention relates to an apparatus for continuous plate formation using belts to produce a plate-form product (a plate-form polymer) by continuously polymerizing a polymerizable raw material, and a method of continuous plate formation using belts by using the apparatus.

### BACKGROUND ART

As a method of continuously producing a plate-form polymer, using methyl methacrylate as a main raw material, there is a continuous casting method using an apparatus for continuous plate formation using belts. This apparatus for continuous plate formation using belts is the apparatus in which a polymerizable raw material is fed to one end of a space between two endless belts facing each other, disposed up and down and provided to run in the horizontal direction at the same speed, and polymerized by a method such as heating along with a movement of the endless belts, and the plate-form polymer is obtained from the other end of the space (for example, refer to Japanese Patent Publication No. Sho 47-33,496).

In a zone where the greater part of a polymerization is carried out in this apparatus for continuous plate formation using belts, the polymerization is carried out while heating and cooling, or heating or cooling running belts being conducted. As a method of heating or cooling, for example, a method of blowing hot air to belt surfaces, a method of scattering warm water on belt surfaces, a method of making belts run in a water bath, and a method of using an infrared heater can be listed. The temperature of heating or cooling may be a fixed ambient temperature throughout the whole zone where the polymerization is carried out or may be changed stepwise or continuously. The temperature of a heating medium should be selected in accordance with a polymerization initiator to be used, however, it needs to be a boiling point of a raw material or below till the greater part of polymerization is carried out. In this step, the method of scattering warm water on the belt surfaces has been frequently used because handling of warm water is easy and heat-transfer coefficient is relatively high in the case of warm water. Further, in a zone after warm water is scattered, generally, the polymerization is completed by raising temperature to a depolymerization temperature of a polymer or below using hot air or an infrared heater.

In the above-mentioned steps, the raw material is heated or cooled to a temperature of a boiling point of the raw material or below in a zone where the greater part of the polymerization is carried out (for example, the foregoing zone where warm water is scattered) because rate of polymerization of the raw material is low, and in a succeeding zone (for example, the foregoing zone where hot air or an infrared heater is used), temperature is raised to fall within a range of from boiling point of the liquid raw material to a depolymerization temperature of the polymer to promptly complete the polymerization. In the following explanation, the latter zone is expressed as a “high-temperature heating zone”, for convenience. Now, in the case that the polymerization initiator is not added or the concentration of the polymerization initiator is lowered for some reason, the polymerization does not occur or retardation of the polymerization occurs. Subsequently, when the raw material enters into the high-temperature heating zone while being in a state of liquid owing to nonoccurrence of the polymerization or retardation of the polymerization, boiling of the liquid raw material occurs, nonreacted monomer and the like are gasified to cause internal pressure of a space sealed with two belts and gaskets to rise, and finally, leakage of gas and a part of the liquid raw material occurs from gaps between the belts and the gaskets. The liquid raw material existing in the space sealed with two belts and gaskets after the leakage forms a foam caused by boiling of the nonreacted monomer.

Such a foaming considerably deteriorates the appearance of plate-form products. Further, the foam strongly adheres to the belts, and it is so difficult to peel the foam from the belts that the time loss becomes large because it is necessary to cautiously operate to peel it so as not to damage the belts. Further, there is a possibility that the leaked gas forms an explosive mixed gas or a flammable mixed gas, and there is a danger of causing explosion or fire in the case that a heat source such as a far infrared heater, which can have a temperature of the ignition point of the gas or above, is used in the zone or in the case that there is a ignition source such as static electricity in the zone.

### DISCLOSURE OF INVENTION

The present invention has been made to solve the problems of the above-mentioned conventional technology. Namely, it is an object of the present invention to provide an apparatus for continuous plate formation using belts and a method of continuous plate formation using belts, which can stably produce an excellent plate-form product (a plate-form polymer) without causing boiling or foaming of a raw material.

To attain the above-mentioned object, the present inventors firstly have investigated a method of checking whether the polymerization of the raw material is sufficiently performed or not (namely, completion or incompletion of the polymerization) in a stage before the raw material enters into the high-temperature heating zone.

When the polymerization does not occur or retardation of the polymerization occurs, it becomes necessary to carry out an operation such as stopping the belts, causing a temperature of a heating medium in the high-temperature heating zone to become the boiling point of a liquid raw material or below, or lowering a transfer speed of the belts. However, if the completion or incompletion of the polymerization is not checked continuously, it is not possible to take prompt measures in case of an unusual situation. Further, it is possible, for example, to extend a zone where the greater part of the polymerization is carried out or to secure a sufficient residence time in the zone where the greater part of the polymerization is carried out by measures such as slowing down the transfer speed of the belts, on the assumption that the polymerization is retarded, however, it is not good in point of the cost of equipment or productivity. Consequently, it becomes necessary to investigate a method of continuously checking the completion or incompletion of the polymerization.

As a method of continuously checking the completion or incompletion of the polymerization, for example, a method of measuring a peak temperature caused by exothermic heat of polymerization or a method of measuring a volume change caused by polymerization-induced shrinkage can be thought of. However, the method of measuring the volume change is not a practical method because it easily becomes difficult to obtain measurement accuracy of the volume change or it easily becomes impossible to detect the volume change by a slight change of plate thickness of the product at the measuring part caused by very little unevenness in an amount of filling of the raw material. On the other hand, as the method of measuring a peak temperature caused by exothermic heat of polymerization, concretely, a method of measuring the peak temperature by bringing a thermometer into contact with surfaces of the belts can be thought of. However, this is not preferable in point of damages on the belts because it is not always the case, depending on an operational condition, that a polymerization peak position locates on a fixed place, so that many thermometers are needed along the advancing direction of the belts and all these thermometers contact with the belts, which may considerably damage the belts.

The present inventors have carried out the above-mentioned investigations and further have diligently carried out investigations to obtain a result that a plate-form product can be produced while the polymerization peak position is easily detected by using the warm water used to heat or cool the belts, and thus have completed the invention.

Namely, a first aspect of the present invention resides in an apparatus for continuous plate formation using belts, in which a polymerizable raw material is fed to one end of a space surrounded by opposed surfaces of two endless belts facing each other and provided to run in the same direction at the same speed and by continuous gaskets running with the belts in a state being disposed at side edges of these belt surfaces so as to be sandwiched between the surfaces, the polymerizable raw material is polymerized in a section where the belts are heated or cooled with warm water, and a plate-form polymer is taken out of the other end of the space, the apparatus comprising:

three or more recovery vessels for recovering the warm water used to heat or cool the belts; and

temperature sensing elements for measuring the temperature of the warm water recovered in every recovery vessel.

A second aspect of the present invention resides in a method of continuous plate formation using belts, which comprises the step of producing a plate-form polymer from a polymerizable raw material comprising methyl methacrylate while measuring temperature of warm water recovered in every recovery vessel with temperature sensing elements by using the foregoing apparatus for continuous plate formation using belts.

In the present invention, the warm water used to heat or cool the belts is recovered to three or more recovery vessels and a polymerization is carried out while the temperature of the warm water recovered is measured in order to continuously check completion or incompletion of the polymerization. As will be explained later, the polymerization peak in a zone where the greater part of the polymerization is carried out can be continuously and easily detected by using the temperature data. Consequently, for example, when the polymerization of a liquid raw material is ceased or retarded, it is possible to adjust a maximum belt speed so as to previously prevent the liquid raw material from entering into a high-temperature polymerizing zone and cause the polymerization peak to be disposed in the zone where the greater part of the polymerization is carried out, so that safety and productivity are improved and it becomes possible to stably produce a plate-form product (a plate-form polymer).

### BRIEF DESCRIPTION OF DRAWINGS

FIG. 1: A schematic side cross section showing an example of an apparatus for continuous plate formation using belts of the present invention

FIG. 2: Each of (a) and (b) is a schematic side cross section showing an example of a disposition of recovery vessels.

FIG. 3: Each of (a), (b) and (c) is a graph showing an example of a difference between a temperature of warm water to be supplied and a temperature of warm water in each recovery vessel.

FIG. 4: A graph showing a plot of a difference between a temperature of warm water to be supplied and a temperature of warm water in each recovery vessel in Example 1

FIG. 5: A graph showing a plot of a difference between a temperature of warm water to be supplied and a temperature of warm water in each recovery vessel in the first operation in Example 2

FIG. 6: A graph showing a plot of a difference between a temperature of warm water to be supplied and a temperature of warm water in each recovery vessel after a running speed of the belts was reduced in Example 2

### BEST MODE FOR CARRYING OUT THE INVENTION

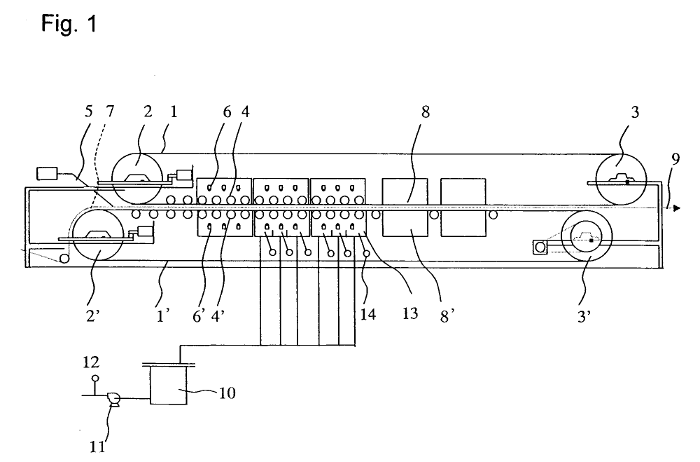

FIG. 1 is a schematic side cross section showing an example of an apparatus for continuous plate formation using belts of the present invention.

In the apparatus shown in this figure, tension of two endless belts 1 and 1′ (stainless steel belts or the like) are given by main pulleys 2, 3, 2′, and 3′, respectively, and a lower belt 1′ is started by the main pulley 3′. A polymerizable liquid raw material containing a polymerizable compound is supplied from a raw material nozzle 5 onto a surface of the lower belt 1′.

Each width of the endless belts 1 and 1′ is preferably 500 mm to 5,000 mm, and each thickness thereof is preferably 0.1 mm to 3 mm. Further, it is preferable that the opposingly disposed endless belts 1 and 1′ be horizontally disposed each other.

An upper endless belt 1 runs in the same direction at the same speed as the lower endless belt 1′ does by frictional force through gaskets or a plate-form polymer which will be mentioned later. The running speed thereof is preferably 0.1 m/min to 10 m/min, and is properly changeable according to circumstances such as a plate thickness to be produced and a timing of changing a kind of the raw material. Further, as a retaining mechanism of the belt surfaces, a plurality of pairs of upper and lower rolls 4 and 4′ are provided along the running direction of the belts in such a way that each axis of the roll is set perpendicular to the running direction of the belts.

The polymerizable liquid raw material is transferred together with the running of the endless belts 1 and 1′, and heated or cooled to be polymerized and solidified. At this time, both side edges between the upper and lower belt surfaces are sealed with elastic gaskets 7.

In a zone where the greater part of the polymerization of the raw material is carried out, the endless belts 1 and 1′ are heated or cooled with warm water. The warm water is very advantageous as a heating medium because it is easy to handle and has a relatively high heat transfer coefficient. A method of heating or cooling with the warm water is not particularly limited as long as it can recover used warm water to three or more recovery vessels which will be explained in detail later. Concretely, a method in which the warm water is scattered on the surfaces of the endless belts 1 and 1′ (surfaces being located opposite side to the space containing the polymerizable raw material) is preferable. Further, it is preferable to use warm water sprays 6 and 6′ as shown in FIG. 1, in point of homogeneously scattering the warm water. Also in the case of scattering the warm water from the warm water spray 6′ upwards to the lower side of the lower belt 1′, it is expressed as scattering the warm water on the surface of the endless belt, for convenience.

In the apparatus shown in FIG. 1, the warm water at a fixed temperature is scattered from the warm water sprays 6 and 6′, and consequently, the endless belts 1 and 1′ are heated or cooled, and as a result, the greater part of the polymerization of the raw material is carried out under the temperature controlled by the warm water. The temperature of the warm water to be supplied here is usually the boiling point of the raw material or below. For example, when the polymerizable liquid raw material containing methyl methacrylate is used, temperature within the range of from 60 to 100° C. is preferable. Concretely, an optimum temperature may be properly selected in accordance with various conditions such as a kind and an amount of a polymerization initiator to be used. Further, the temperature of the warm water to be supplied may be a uniformly fixed temperature throughout the whole zone where the greater part of the polymerization is carried out (the section between the warm water sprays 6 and 6′ in FIG. 1) or may be changed stepwise or continuously. Further, the amount of the warm water to be supplied is preferably 10 to 50 L/min to 1 m² of a surface area of the belts in the zone where the greater part of the polymerization is carried out.

After the greater part of the polymerization of the raw material is carried out, a zone where temperature is further raised to promptly complete the polymerization (high-temperature heating zone) is provided. This zone corresponds to a section where temperature is further raised by far infrared heaters 8 and 8′ in FIG. 1. The polymerization is completed in this zone and finally a plate-form product 9 is taken out. The temperature of the high-temperature heating zone is usually in the range of a boiling point of the liquid raw material or above and a depolymerization temperature of a polymer or below. For example, when the polymerizable liquid raw material containing methyl methacrylate is used, the temperature within the range of from 100 to 150° C. is preferable. The method of heating is not limited to the far infrared heater but, for example, another heating method such as hot air may also be used.

In the next place, recovery vessel 13 for recovering the warm water used to heat or cool the belts will be explained.

In FIG. 1, the warm water scattered from the warm water sprays 6 and 6′ on the surfaces of the endless belts 1 and 1′ is recovered to each of three or more recovery vessels 13 after heating or cooling the belts 1 and 1′ and successively falling downward. Further, thermometers 14 (temperature sensing elements) to detect the temperature of the warm water recovered are provided in every recovery vessel 13, and the polymerization step is managed while the temperature of the warm water recovered in every recovery vessel 13 is measured with thermometers 14. Each warm water recovered in the recovery vessel 13 is further gathered to a warm water tank 10, and heated again in the warm water tank 10 or in supply piping of the warm water to a desired temperature with a heat source such as steam or an electric heater, and supplied again to the warm water sprays 6 and 6′ with a warm water pump 11 or the like. The temperature of the warm water after the temperature is raised again is measured with a thermometer 12. A position and a number of the thermometer 12 are not particularly limited, and for example, the thermometer 12 can be equipped to each of the warm water sprays 6 and 6′. A number of the warm water tank 10 is not particularly limited either, and it may be plural. A type of the thermometer 12 or 14 is not limited as long as it can measure a difference between a temperature of the warm water to be supplied and a temperature of the warm water recovered. For example, a thermocouple, a resistance bulb, or a bimetal thermometer can be used.

In the present invention, the three or more recovery vessels 13 may be the ones in which each vessel can distinctively recover the warm water at different positions in a running direction of the belts. The recovery vessels 13 shown in FIG. 1 are disposed at a lower part of the lower belt 1′. Further, in FIG. 1, the three or more recovery vessels 13 are constructed by dividing a long vessel continuously extended along the running direction of the belts into three or more sections. Therefore, the warm water dropping from both edges of the belts to downward side is recovered in different recovery vessels 13 in accordance with positions in the running direction of the belts.

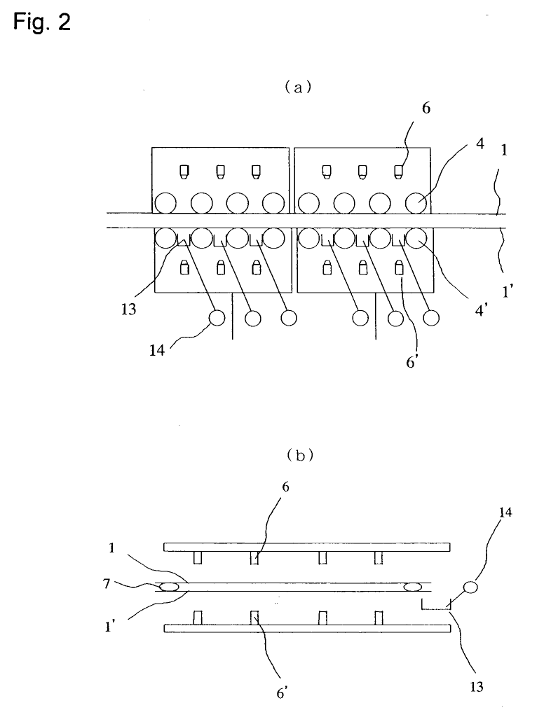

In FIG. 1, an example was shown, in which the three or more recovery vessels 13 are disposed continuously along the running direction of the belts, however, the present invention is not limited to this, and the three or more recovery vessels 13 may be disposed intermittently. FIG. 2(a) is a schematic drawing showing an example in which the three or more recovery vessels 13 are disposed intermittently along the running direction of the belts. Concretely, each independent recovery vessel 13 is disposed in a position corresponding to a space between lower rolls 4′. In such a case where the recovery vessels 13 are disposed intermittently, not the whole but a part of the warm water used to heat or cool the belts is recovered in the recovery vessels 13. Namely, in the present invention, either the whole or a part of the warm water used to heat or cool the belts may be recovered in the three or more recovery vessels 13.

The positions where the recovery vessels 13 are disposed are not particularly limited either. For example, in the above-mentioned example, the recovery vessels 13 may also be disposed only on one side of the vicinity of the side edges in the transverse direction of the belts 1 and 1′ as shown in FIG. 2(b).

Further, the three or more recovery vessels 13 may be disposed not only in the whole zone where the greater part of the polymerization is carried out (the section of the warm water sprays 6 and 6′ in FIG. 1) but also only in the zone and the surroundings where a polymerization peak is supposed to appear. The length of the zone where the three or more recovery vessels 13 are disposed is preferably 20 to 100%, and more preferably 50 to 100%, provided that the length from an inlet to an outlet of the zone where the greater part of the polymerization is carried out is 0 to 100%.

In the present invention, the polymerization is continuously carried out while the temperature of the warm water recovered in every recovery vessel is measured by using the apparatus having the structure explained above. Hereinafter, a method of detecting the polymerization peak will be explained.

The polymerizable raw material is heated, and progressively polymerized and solidified as the endless belts 1 and 1′ run, and a temperature peak caused by exothermic heat of polymerization, namely a polymerization peak, appears. Because the rate of polymerization at the time when the polymerization peak appears is usually 50 to 90% by mass, it is possible to conclude that the polymerization has advanced to a considerable extent if the polymerization peak has appeared. The zone where the polymerization peak appears has high temperature owing to the exothermic heat of polymerization. Therefore, the warm water to be supplied with the warm water sprays 6 and 6′ has a role to cool the belts at the zone. Further, in the zone where the polymerization is carried out, the temperature of the warm water recovered becomes higher than that of the warm water to be supplied owing to the heat transfer from the belts to the warm water. In the zone where the polymerization peak appears, a difference between the temperature of the warm water recovered and the temperature of the warm water to be supplied becomes large as compared with the difference of the temperatures in another zone. Consequently, for example, the polymerization peak position can be known by detecting the zone where the difference between the temperature of the warm water recovered and the temperature of the warm water to be supplied becomes the largest.

To recognize the temperature of the warm water recovered as a peak, it is necessary to judge by comparing temperature data of the zone corresponding to the polymerization peak position with temperature data of zones other than that. Concretely, it is preferable to recognize each existence of the starting point, the peak point, and the end point of a temperature rise by at least three recovery vessels. This will be explained in the following by using figures.

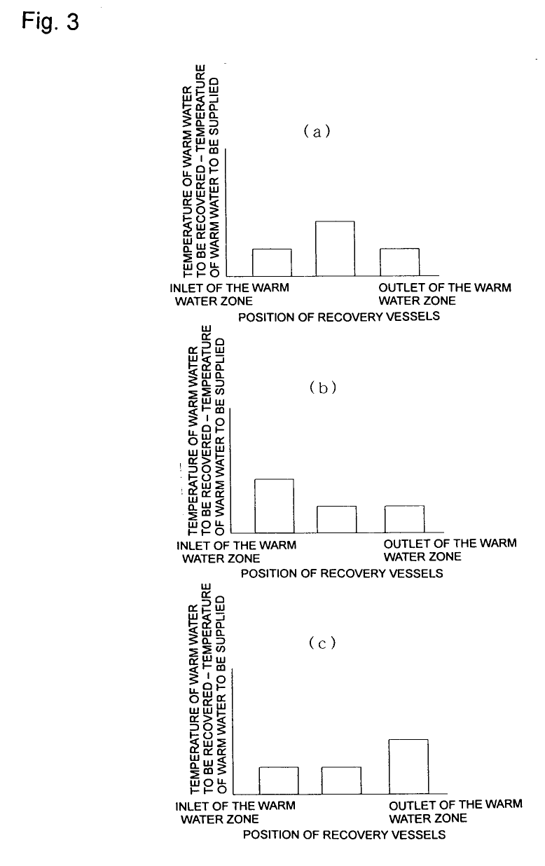

FIG. 3(a) is a graph in which a value obtained by subtracting the temperature of the warm water to be supplied from the temperature of the warm water to be recovered (temperature difference) is plotted for every recovery vessel in the case of using three intermittently disposed recovery vessels. In this example, the temperature difference with regard to the warm water recovered in the center recovery vessel is the largest, and hence, it is recognized that the polymerization peak is located around the position of the center recovery vessel.

FIG. 3(b) is a graph showing another example in the case of using the same three recovery vessels as in the case of FIG. 3(a). In this example, the temperature difference with regard to the recovery vessel on an inlet side of the warm water zone (raw material feeding side) is the largest. From this result, it is recognized that the polymerization peak is located around the position of the recovery vessel disposed at the most inlet side among the three recovery vessels or in the position of further nearer to the raw material feeding side. In this case, it is possible to move the polymerization peak to the center position (the position in FIG. 3(a)), for example, by increasing a running speed of the belts, and thereby to avoid the operation that deteriorates productivity.

FIG. 3(c) is a graph showing another example in the case of using the same three recovery vessels as in the case of FIG. 3(a). In this example, the temperature difference with regard to the recovery vessel on an outlet side of the warm water zone (product takeout side) is the largest. From this result, it is recognized that the polymerization peak is located around the position of the recovery vessel disposed at the most outlet side among the three recovery vessels or in the position of further outlet side. In this case, there is a possibility that the polymerization peak is located further nearer to the product takeout side passing the outlet of the warm water zone. Therefore, it is possible to change the polymerization peak to the center position (the position in FIG. 3(a)), for example, by decreasing a running speed of the belts, and thereby to promptly avoid a transfer of the raw material in which the polymerization is still not advanced into the high-temperature heating zone.

As explained above, it is possible to recognize the polymerization peak position easily, to promptly cope with unusual situations, and to realize a stable production step, by disposing three or more recovery vessels for recovering the warm water used to heat or cool the belts along the running direction of the belts, and by measuring the temperature of the warm water recovered in every recovery vessel. In the above explanation, the example in the case of the three recovery vessels was explained, however, it is possible to detect the position of the polymerization peak more clearly if the number of the recovery vessels is increased. However, this is disadvantageous in the cost of equipment because the total number of the recovery vessels and temperature sensing elements equipped with them increases. From these respects, it is preferable that the number of the recovery vessels be about 5 to 20. Further, it is preferable that a length and an interval for disposition of each recovery vessel along the running direction of the belts in the case of intermittently disposing three or more recovery vessels along the running direction of the belts, or a length of each recovery vessel along the running direction of the belts in the case of continuously constructing three or more recovery vessels by dividing a long vessel (refer to FIG. 1) be one tenth of the length of the zone where the greater part of the polymerization is carried out or less.

The raw material of a plate-form polymer can be properly selected in accordance with a target plate-form polymer. The apparatus for continuous plate formation of the present invention is particularly suitable for producing a methacrylic resin plate using methyl methacrylate as a main raw material. In the case of producing the methacrylic resin plate, it is preferable to use a polymerizable raw material containing 50% by mass or more of methyl methacrylate. As a representative polymerizable raw material, methyl methacrylate alone or a mixture of methyl methacrylate and another copolymerizable monomer can be listed; further, a syrup obtained by dissolving methyl methacrylate polymer in methyl methacrylate or its mixture, or a syrup in which part of methyl methacrylate or its mixture is previously polymerized can also be listed.

As the other copolymerizable monomer, for example, an acrylate such as methyl acrylate, ethyl acrylate, n-butyl acrylate, or 2-ethylhexyl acrylate; a methacrylate other than methyl methacrylate such as ethyl methacrylate, n-butyl methacrylate, or 2-ethylhexyl methacrylate; or vinyl acetate, acrylonitrile, methacrylonitrile, or styrene can be listed. In the case of syrup, it is preferable that the syrup be prepared to have polymer content of 50% by mass or less in consideration of the fluidity of the polymerizable raw material.

A chain transfer agent can also be added to the polymerizable raw material, when it is needed. As the chain transfer agent, for example, a primary, secondary, or tertiary mercaptan having an alkyl group or a substituted alkyl group can be used. As its concrete example, n-butyl mercaptan, i-butyl mercaptan, n-octyl mercaptan, n-dodecyl mercaptan, s-butyl mercaptan, s-dodecyl mercaptan, or t-butyl mercaptan can be listed.

Further, a polymerization initiator is usually added to the polymerizable raw material. As its concrete example, an organic peroxide such as tert-hexyl peroxypivalate, tert-hexyl peroxy-2-ethylhexanoate, di-isopropyl peroxydicarbonate, tert-butyl peroxyneodecanoate, tert-butyl peroxypivalate, lauroyl peroxide, benzoyl peroxide, tert-butyl peroxyisopropylcarbonate, tert-butyl peroxybenzoate, dicumyl peroxide, or di-tert-butyl peroxide; or an azo compound such as 2,2′-azobis(2,4-dimethylvaleronitrile), 2,2′-azobisisobutyronitrile, 1,1′-azobis(1-cyclohexanecarbonitrile), or 2,2′-azobis(2,4,4-trimethylpentane) can be listed.

Further, it is also possible to add various additives, for example, an ultraviolet light absorber, a light stabilizer, an antioxidant, a plasticizer, a dye, a pigment, a mold release agent, and a multilayered acrylic rubber to the raw material, when it is needed. Further, it is also possible to produce an artificial marble plate-form polymer by adding inorganic fillers to the polymerizable raw material.

The thickness of the plate-form polymer to be produced by the present invention is preferably about 0.3 to 20 mm. Hereinafter, the present invention will be explained in more detail by examples, however, the present invention is not limited to these examples. In the following description, “% by mass” is abbreviated to “%” and “part(s) by mass” is abbreviated to “part(s)”.

### EXAMPLE 1

To 100 parts of methyl methacrylate syrup having a rate of polymerization of 20% (viscosity at 20° C. being 1 Pa·s), 0.1 part of tert-hexyl peroxypivalate (manufactured by NOF CORPORATION, trade name: PERHEXYL PV) as a polymerization initiator, and 0.005 part of dioctyl sodium sulfosuccinate as a mold release agent were added and mixed homogeneously to obtain a polymerizable liquid raw material. The polymerizable liquid raw material was degassed in a vacuum container, and a plate-form product (a plate-form polymer) of 5 mm in thickness and 1,800 mm in width was produced using the apparatus of FIG. 1 (the recovery vessels being the structure of FIG. 2(a)).

In the present example, this apparatus has a total length of 10 m, and two endless belts 1 and 1′ made of stainless steel have a thickness of 1.5 mm and a width of 2 m, and a tension of 30 Mpa is given to both of the upper and lower belts by oil pressure. Further, as gaskets 7, gaskets 7 made of polyvinyl chloride are provided.

Further, this apparatus has 5 m of a heating zone with warm water sprays 6 and 6′ as a zone where the greater part of the polymerization is carried out. Succeeding to the heating zone with the warm water sprays 6 and 6′, the apparatus has 2 m of a heating zone with far infrared heaters 8 and 8′ as a high-temperature heating zone to complete the polymerization. Further, as for recovery vessels, recovery vessels 13 (50 mm in width, 50 mm in length, and 60 mm in height) are disposed in a position of 3 to 5 m from a raw material feeding side and at intervals of 0.2 m in the heating zone with the warm water sprays 6 and 6′ as shown in FIG. 2(a). The number of the recovery vessels 13 is 10. Further, thermometers 14 (temperature sensing elements) made of resistance bulbs are equipped to every recovery vessel so as to measure the temperature of the warm water recovered in the recovery vessels 13.

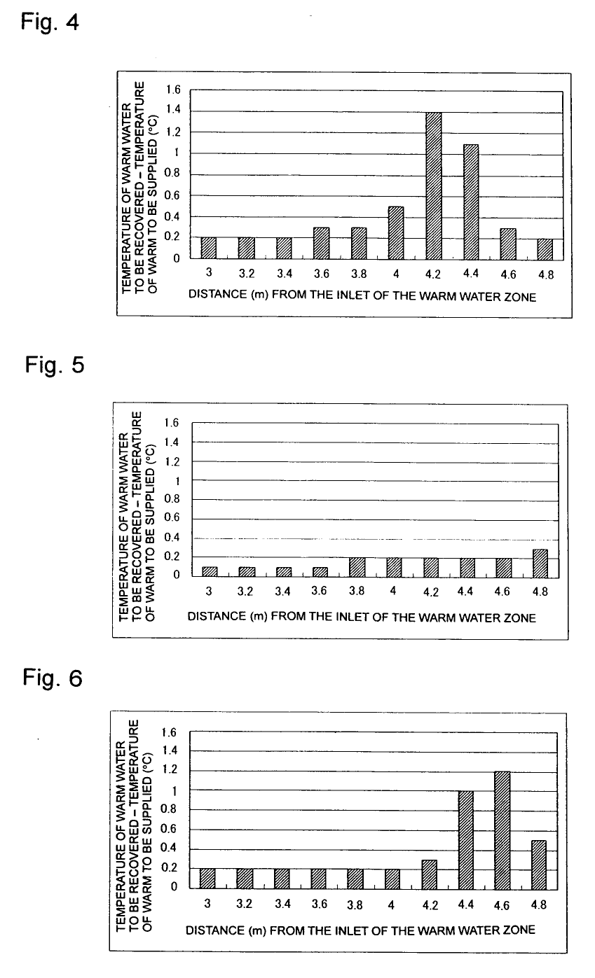

Using the apparatus as mentioned above, a plate-form product of 5 mm in thickness and 1,800 mm in width was produced by operating the endless belts 1 and 1′ with a running speed of 130 mm/min and scattering the warm water of 76° C. from the warm water sprays 6 and 6′ to the surfaces of the belts 1 and 1′. Further, at the same time, differences between the temperatures of the warm water to be recovered by ten recovery vessels 13 and the temperature of the warm water to be supplied were plotted to catch hold of a polymerization peak. FIG. 4 is a graph showing the result of the plots of the present example.

From the result shown in FIG. 4, it was recognized that the polymerization peak was located at 4.2 m from the raw material feeding side of the heating zone with the warm water sprays 6 and 6′. Further, the plate-form product obtained in the present example was an excellent product without having any air bubbles.

Further, in the production step of the present example, a thermocouple was introduced with the raw material from the end of the belts at the raw material feeding side to measure temperature changes with time of inside liquid of the raw material near the thermocouple and to compare them with positions of the polymerization apparatus for confirmation. As a result, it was confirmed that the peak of exothermic heat of polymerization was located at 4.2 m from the raw material feeding side of the heating zone with the warm water sprays 6 and 6′ and this coincided well with the result shown in FIG. 4.

### EXAMPLE 2

The same procedure as in Example 1 was performed except that the amount of tert-hexyl peroxypivalate, which is a polymerization initiator in the polymerizable raw material, was reduced from 0.1 part to 0.07 part, and a plate-form product of 5 mm in thickness and 1,800 mm in width was produced by operating the endless belts 1 and 1′ with a running speed of 130 mm/min. FIG. 5 is a graph showing the result of the plots. As shown in FIG. 5, the temperature of the warm water recovered rose toward the outlet side of the heating zone with the warm water sprays 6 and 6′, however, there didn't appear any end point that can be judged as a polymerization peak. Therefore, it was recognized that the polymerization peak was located in the zone succeeding to the heating zone with the warm water sprays 6 and 6′. Further, the plate-form product thus obtained had air bubbles in the plate. Further, from the result of the measurement using the thermocouple introduced together with the raw material, it was confirmed that the peak of exothermic heat of polymerization was located at 5.4 m from the raw material feeding side of the heating zone with the warm water sprays 6 and 6′, and this position was located out of the heating zone with the warm water sprays 6 and 6′, and this coincided with the result shown in FIG. 5.

Subsequently, the running speed of the endless belts 1 and 1′ was changed to 110 mm/min, and operation was resumed. FIG. 6 is a graph showing the result of the plots. From the result shown in FIG. 6, it was recognized that the polymerization peak was located at 4.6 m from the raw material feeding side of the heating zone with the warm water sprays 6 and 6′, and the polymerization peak was located within the heating zone with the warm water sprays 6 and 6′. The plate-form product thus obtained was an excellent product without having any air bubbles. Further, from the result of the measurement using the thermo-couple introduced together with the raw material, it was confirmed that the polymerization peak was located at 4.6 m from the raw material feeding side of the heating zone with the warm water sprays 6 and 6′, and this coincided with the result shown in FIG. 6.

What is claimed is:

1. An apparatus for continuous plate formation using belts, in which a polymerizable raw material is fed to one end of a space surrounded by opposed surfaces of two endless belts facing each other and provided to run in the same direction at the same speed and by continuous gaskets running with the belts in a state being disposed at side edges of these belt surfaces so as to be sandwiched between the surfaces, the polymerizable raw material is polymerized in a section where the belts are heated or cooled with warm water, and a plate-form polymer is taken out of the other end of the space, the apparatus comprising:
three or more recovery vessels for recovering the warm water used to heat or cool the belts; and
temperature sensing elements for measuring the temperature of the warm water recovered in every recovery vessel.

2. The apparatus for continuous plate formation using belts according to claim 1, wherein each of the three or more recovery vessels can distinctively recover the warm water at different positions in a running direction of the belts.

3. The apparatus for continuous plate formation using belts according to claim 1, further comprising a measure for measuring a temperature of the warm water to be supplied to heat or cool the belts.

4. The apparatus for continuous plate formation using belts according to claim 1, wherein a measure for supplying the warm water to heat or cool the belts is a warm water spray.

5. A method of continuous plate formation using belts, comprising the step of producing a plate-form polymer from a polymerizable raw material comprising methyl methacrylate while measuring temperature of warm water recovered in every recovery vessel with temperature sensing elements by using the apparatus for continuous plate formation using belts according to claim 1.

6. The method of continuous plate formation using belts according to claim 5, wherein a polymerization peak position is detected from a difference between a measured temperature of warm water to be supplied to heat or cool the belts and a measured temperature of warm water recovered.

7. The method of continuous plate formation using belts according to claim 6, wherein a running speed of the belts is adjusted for adjusting the polymerization peak position.

8. The method of continuous plate formation using belts according to claim 5, wherein methyl methacrylate is a main raw material.
